(19) United States
(12) Patent Application Publication
(10) Pub. No.: US 2008/0234095 A1
(43) Pub. Date: Sep. 25, 2008

(54) Planetary Gear

(75) Inventor: Anders Peter Kolstrup, Valby (DK)

Correspondence Address: WILLIAM J. SAPONE;COLEMAN SUDOL SAPONE P.C., 714 COLORADO AVENUE, BRIDGE PORT, CT, 06605, US

(73) Assignee: Rotrex A/S, Herlev (DK)

(21) Appl. No.: 10/585,813

(22) PCT Filed: Jan. 21, 2005
(86) PCT No.: PCT/DK2005/000040

§ 371 Date: Jun. 2, 2008

(30) Foreign Application Priority Data
Jan. 22, 2004 (DK) PA2004 00081

(51) Int. Cl. F16H 13/08

(52) U.S. Cl. 475/347

(57) ABSTRACT

When, according to the invention, a one-stage planetary gear is constructed with radially resilient planet wheels and sun shaft (1), and where the centre axes are parallel with the sun axis and positioned closer to it than the axes of the planet wheels (2), a good engagement between the contact-bearing surfaces and thereby a high degree of moment transfer are achieved. It is more-over ensured that the gear can operate at en extremely high number of revolutions.

### STATE OF THE ART

The invention relates to a planetary gear incorporated in a gear housing with an outer ring and with planet wheels and a sun shaft in particular for use at a high number of revolutions and high gear ratios.

Planetary gears for high speeds and gear ratios are known from WO 02/064997. This gear is provided with at least three planet wheels, and therefore the gear ratio cannot exceed 13.6:1 because of physical conditions, which cause the planet wheels to make contact with each other at greater gear ratios.

### OBJECT OF THE INVENTION

Since the need for greater gear ratios is increasing because of the demand for high speed compressors and the like, the object of the invention is to meet the requirements of high speed as well as gear ratio.

This is achieved according to the invention by a gear having two essentially diametrically positioned planet wheels, which partly roll against the outer ring and partly against a sun shaft, said planet wheels being provided with a shaft which is mounted on the stationary front plate and a support plate secured to the front plate, respectively.

Both a high speed and a greater gear ratio are ensured in this simple manner owing to the structure with just two planet wheels.

To this should be added that a great transfer of moment is achieved between the parts because of the pressure between the frictional faces, which will vary in a controlled manner with the output moment.

When, as stated in claim 2, the planet shafts are mounted with a radial clearance in the front plate and the support plate, respectively, it is ensured that the planet wheels are pressed harder against the sun shaft when the gear is in operation.

When, as stated in claim 3, the sun shaft is mounted in resilient bushings in the front plate and the support plate, respectively, an optimum transfer of moment is achieved even at high speeds, since the planet wheels will be pressed against the sun shaft, as the bias required for the transfer of moment may be provided.

When, as stated in claim 4, the bearings of the sun shaft are replaced by a further set of planet wheels which engage the sun shaft, this will be stabilized and controlled so that the gear may operate at very high speeds.

### THE DRAWING

Examples of embodiments of the gear according to the invention will be described more fully below with reference to the drawing, in which

FIG. 1 shows a sectional view of a gear with mounted planet wheels and sun shaft,

FIG. 2 shows a sectional view of the gear seen in the direction II-II in FIG. 1,

FIG. 3 shows a sectional view of a second exemplary embodiment of the gear, where the sun wheel is supported by offset planet wheels, and

FIG. 4 shows a sectional view of this gear seen in the direction IV-IV in FIG. 3.

### DESCRIPTION OF EXEMPLARY EMBODIMENTS

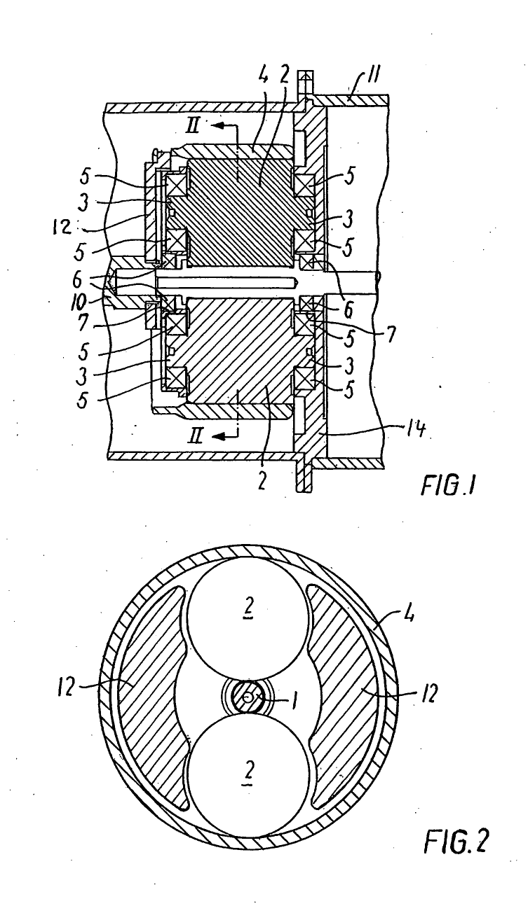

FIGS. 1 and 2 show a first-example of a one-stage gear. The gear comprises a sun shaft 1 which is mounted in high speed bearings of a ceramic or similar type.

The outermost bearing 6 is mounted in the front plate 14 of the gear housing 11, while the innermost bearing 6 is mounted in the support plate 12 which is secured to the front plate 14, whereby a rigid bearing housing is provided.

Both sets of bearings may be moved in a radial direction, said bearings 6 being mounted in resilient bushings 7.

Each of the planet wheels 2 is provided with stub shafts 3 on both sides, said shafts 3 being mounted in high speed bearings 5 in bores in the front plate 14 and the support plate 12, respectively.

The structure shown is unique in that the planet shaft bearings 5 are arranged outside the planet wheels 2 in an axial direction.

Moreover, the bearings 5 are typically about 5-8/100 mm smaller than the cooperating bores.

The centre shafts of the planet wheels 2 are parallel with the centre shaft of the sun shaft 1, and they are disposed closer to the sun axis when these are present in their state of operation, where the bearings 5 of the shaft parts are in engagement with the inner surfaces of the cooperating surfaces on the bores.

The support plate 12 gives the mounted parts a sturdy position by means of strong stays, as indicated in FIG. 2.

The centrally rotatable sun shaft 1 and the two planet wheels 2 arranged diametrically around the shaft rotate about their own axes and with means for resiliently pressing the peripheral outer face of the planet wheels 2 into force-transferring engagement with the peripheral outer face of the sun shaft 1.

The internal surface of the outer ring 4 is machined for the greatest possible friction, traction, with the surfaces of the planet wheels 2.

The internal diameter of the outer ring 4 is typically 0.1-0.4% smaller than the geometrical circle which surrounds the planet wheels 2, whereby the bias required for the transfer of moment is achieved.

These conditions ensure that the planet wheels 2 are pressed hard against the sun shaft 1 when the gear is in its state of operation, where both planet wheels 2 are in engagement with the sun shaft 1, and the bearings 5 are in engagement with the inner surfaces in the cooperating bores.

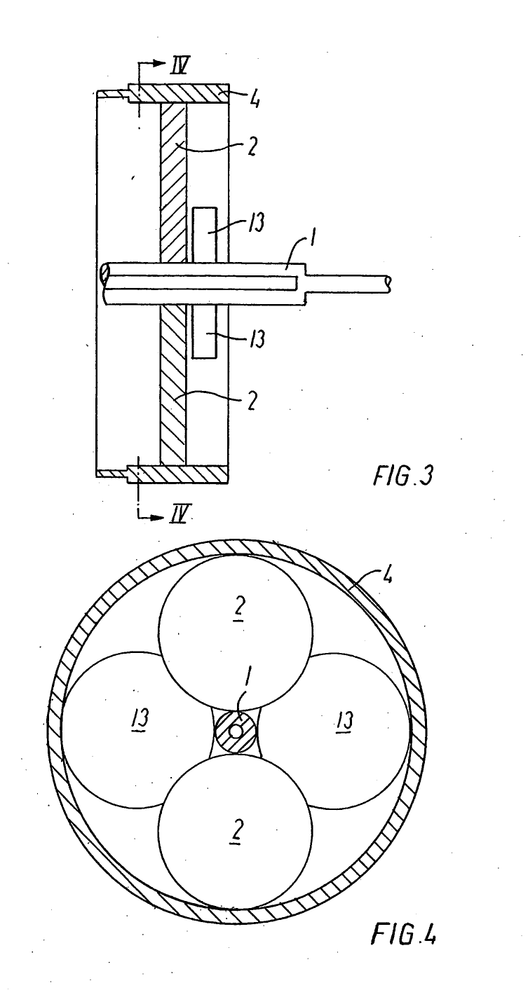

FIGS. 3 and 4 show a sketch of a further embodiment, where the exemplary embodiment discussed with reference to FIGS. 1 and 2 is provided with two further planet wheels 13.

Hereby, the sun shaft 1 may be controlled by the planet wheels without any need for bearings, which allows operation at extremely high speeds of rotation as the sun shaft 1 is controlled by the four planet wheels 2, 13. The drawing does not show bearings, etc. for the planet wheels, but these may of the type which are mentioned in connection with the exemplary embodiment shown in FIGS. 1 and 2.

In both exemplary embodiments, the gear may be used as a speed increaser and as a speed reducer, respectively, by selection of drive shaft and output shaft. The drive shaft shown in FIG. 1 provides speed increase, while selection of the sun shaft 1 as a drive shaft provides reduction.

1. A planetary gear incorporated in a gear housing with an outer ring and with planet wheels and a sun shaft in particular for use at a high number of revolutions and high gear ratios, characterized in that the gear comprises two essentially diametrically positioned planet wheels (2) which partly roll against the outer ring (4) and partly against a sun shaft (1), said planet wheels (2) being provided with a shaft (3) which is mounted (5) on the stationary front plate (14) and on the support plate (12), respectively.

2. A planetary gear according to claim 1, characterized in that the bearings (5) of the planet shafts (3) have a predetermined radial clearance in their bores in the front plate (14) and the support plate (12), respectively.

3. A planetary gear according to claims 1 and 2, characterized in that the sun shaft (1) is mounted in high speed bearings (6), of which the outermost bearing (6) is mounted in a resilient bushing (7) in the front plate (14) and the innermost bearing (6) in a resilient bushing (7) in the support plate (12).

4. A planetary gear according to claims 1 and 2, characterized in that two further planet wheels (13) are mounted, extending in parallel with the planet wheel (2), said further planet wheels (13) extending essentially diametrically opposite such that the four planet wheels (2, 13) engage the sun shaft (1) and the outer ring (4) with a mutual angular position of 90°.
